(19) United States
(12) Patent Application Publication
(10) Pub. No.: US 2012/0072755 A1
(43) Pub. Date: Mar. 22, 2012

(54) METHOD OF CONTROLLING OPERATION MODE OF STORAGE DEVICE, AND STORAGE DEVICE IMPLEMENTING THE STORAGE

(75) Inventor: Walter Jun, Seoul (KR)

(73) Assignee: SAMSUNG ELECTRONICS CO., LTD., Suwon-si (KR)

(21) Appl. No.: 13/233,078

(22) Filed: Sep. 15, 2011

(30) Foreign Application Priority Data
Sep. 20, 2010 (KR) 10-2010-0092511

(51) Int. Cl. G06F 1/26

(52) U.S. Cl. 713/340

(57) ABSTRACT

A method and apparatus control an operation mode of a storage device, including determining, by the storage device, an external power connection state of a host device connected to the storage device; and determining the operation mode of the storage device according to the determined external power connection state. The operation mode is determined to be a first mode when external power is connected to the host device and the operation mode is determined to be a second mode when the external power is not connected to the host device, where power consumption in the second mode being smaller than power consumption in the first mode.

### CROSS-REFERENCE TO RELATED APPLICATIONS

A claim of priority under 35 U.S.C. §119 is made to Korean Patent Application No. 10-2010-0092511, filed on Sep. 20, 2010, in the Korean Intellectual Property Office, the entire contents of which are hereby incorporated by reference.

### BACKGROUND

The inventive concept relates to a method and apparatus for controlling an operation mode of a storage device, and more particularly, to a method and apparatus for adaptively setting an operation mode of a data storage device based on a state of a host device.

A disk drive, which is one example of a storage device, operates in a computer system by writing data to a recording medium or reading data from the storage medium according to a command generated by a host device. Thus, there is a need for optimizing the performance and energy efficiency of the disk drive in a computer system.

### SUMMARY

The inventive concept provides a method for controlling an operation mode of a storage device, by which the operation mode of the storage device is adaptively determined based on a state of a host device connected to the storage device. The inventive concept also provides a storage device for adaptively determining an operation mode thereof based on a state of a host device connected thereto. The inventive concept also provides a computer system implementing a method of adaptively determining an operation mode of a storage device based on a state of a host device connected to the storage device. The inventive concept also provides a storage medium having recorded thereon program code for executing a method of adaptively determining an operation mode of a storage device based on a state of a host device connected to the storage device.

According to an aspect of the inventive concept, there is provided a method of controlling an operation mode of a storage device. The method includes determining, by the storage device, an external power connection state of a host device connected to the storage device; and determining the operation mode of the storage device according to the determined external power connection state. The operation mode is determined to be a first mode when external power is connected to the host device and the operation mode is determined to be a second mode when the external power is not connected to the host device, where power consumption in the second mode being smaller than power consumption in the first mode.

According to an embodiment of the inventive concept, the method may further include monitoring, by the host device, the external power connection state of the host device; generating a first signal indicating the external power connection state of the host device based on the monitoring; and transmitting the first signal to the storage device. The external power connection state of the host device is determined by the storage device based on the first signal.

According to an embodiment of the inventive concept, the external power connection state of the host device may be monitored using a Basic Input/Output System (BIOS) program stored in the host device.

According to an embodiment of the inventive concept, the first signal may be transmitted to the storage device through a connector which connects the host device with the storage device.

According to an embodiment of the inventive concept, the connector may include a power connector.

According to an embodiment of the inventive concept, the connector may include a Serial Advanced Technology Attachment (SATA) interface power connector, and the first signal is transmitted to the storage device through an eleventh pin port of the SATA interface power connector.

According to an embodiment of the inventive concept, determining the external power connection state of the host device may include receiving a signal having a logic state of a particular pin port of a connector, which connects the host device with the storage device, and determining the external power connection state based on the logic state.

According to an embodiment of the inventive concept, a clock frequency of a Central Processing Unit (CPU) included in the storage device or a clock frequency of a memory device may be set to be higher in the first mode than in the second mode.

According to an embodiment of the inventive concept, transition of the storage device to an idle state may be blocked in the first mode, and the transition of the storage device to the idle state may be permitted in the second mode.

According to another aspect of the inventive concept, there is provided a storage device including a connector and a processor. The connector electrically connects a host device with the storage device and is configured to transmit a first signal indicating an external power connection state of the host device to the storage device. The processor is configured to determine an operation mode of the storage device based on the first signal received through the connector and to control the storage device according to the determined operation mode. The processor determines the operation mode of the storage device to be a first mode when the external power connection state indicates that external power is connected to the host device and determines the operation mode of the storage device to be a second mode, in which power consumption is smaller than in the first mode, when the external power is not connected to the host device.

According to an embodiment of the inventive concept, the connector may include an SATA interface power connector, in which an eleventh pin port thereof may be assigned as a pin port for transmitting the first signal.

According to an embodiment of the inventive concept, the processor may determine the external power connection state of the host device by using a Basic Input/Output System (BIOS) program stored in the host device to generate the first signal.

According to an embodiment of the inventive concept, the first signal may include an external power signal of the host device.

According to an embodiment of the inventive concept, the processor may include a CPU configured to determine the operation mode of the storage device based on a logic state of the first signal and to generate a clock control signal corresponding to the determined operation mode, and a clock signal generator configured to generate one or more clock signals having frequencies that vary according to the clock control signal. The clock signals generated by the clock signal generator may include a clock signal used in the CPU or a memory device, and a frequency of a clock signal generated in the first mode may be set to be higher than a frequency of a clock signal generated in the second mode.

According to an embodiment of the inventive concept, the clock signal generator may include a clock source generator configured to generate multiple clock signals having different frequencies, and a multiplexer configured to select and output one the clock signals according to the clock control signal. The multiplexer may set a frequency of a clock signal selected and output in the first mode to be higher than a frequency of a clock signal selected and output in the second mode.

According to an embodiment of the inventive concept, the processor may block transition of the storage device to an idle state in the first mode, and permit the transition of the storage device to the idle state in the second mode.

According to an embodiment of the inventive concept, the storage device may include a disk drive or a Solid State Drive (SSD).

According to another aspect of the inventive concept, there is provided a computer system including a host device determining an external power connection state of the host device and generating a first signal corresponding to the determination result; a connector electrically connecting the host device with a storage device to transmit the first signal to the storage device; and a processor controlling an operation mode of the storage device based on the first signal received through the connector and controlling the storage device according to the determined operation mode. The processor determines the operation mode of the storage device as a first mode when external power is connected to the host device and the operation mode is determined as a second mode, in which power consumption is smaller than in the first mode, when the external power is not connected to the host device.

According to another aspect of the inventive concept, there is provided a method of controlling an operation mode of a storage device. The method includes monitoring, by a host device connected to the storage device, a connection state of external power of the host device; determining whether the external power is connected to the host device based on the monitoring of the external power connection state; setting a first signal to a first logic state when the external power is determined to be connected to the host device, and setting the first signal to a second logic state when the external power is determined to be not connected to the host device; and transmitting the first signal to the storage device. The operation mode of the storage device is determined based on the first signal.

### BRIEF DESCRIPTION OF THE DRAWINGS

Exemplary embodiments of the inventive concept will be more clearly understood from the following detailed description taken in conjunction with the accompanying drawings, in which:

FIG. 1 is a structural diagram of a computer system, according to an embodiment of the inventive concept;

FIG. 2 is a detailed structural diagram of a host device shown in FIG. 1;

FIG. 3 is a diagram of a software operating system of a storage device shown in FIG. 1;

FIG. 4 is a plan view of a head disk assembly of a disk drive, according to an embodiment of the inventive concept;

FIG. 5 is an electrical structural diagram of a disk drive, according to an embodiment of the inventive concept;

FIG. 6 is a structural diagram of a solid state drive, according to an embodiment of the inventive concept;

FIG. 7 is a structural diagram of a process of a storage device, according to an embodiment of the inventive concept;

FIG. 8 is a detailed structural diagram of an embodiment of a clock generator shown in FIG. 7;

FIG. 9 is a detailed structural diagram of another embodiment of the clock generator shown in FIG. 7;

FIG. 10 is a detailed structural diagram of another embodiment of the clock generator shown in FIG. 7;

FIG. 11 is a flowchart of a method of controlling an operation mode of a storage device, executed in a host device of a computer system, according to an embodiment of the inventive concept; and

FIG. 12 is a flowchart of a method of controlling an operation mode of a storage device, executed in the storage device of a computer system, according to an embodiment of the inventive concept.

### DETAILED DESCRIPTION OF THE EMBODIMENTS

Embodiments of the inventive concept will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated.

As shown in FIG. 1, a computer system according to an embodiment of the inventive concept includes a storage device 1000, a host device 2000, and a connector 3000.

More specifically, the storage device 1000 includes a processor 110, Read Only Memory (ROM) 120, Random Access Memory (RAM) 130, a media interface (UF) 140, media 150, a host I/F 160, a bus 170, and an I/F port P2.

The connector 3000 is a means for electrically connecting an I/F port P1 of the host device 2000 with the I/F port P2 of the storage device 1000, and includes a data connector and a power connector. For example, when a Serial Advanced Technology Attachment (SATA) I/F is used, the connector 3000 may include a 7-pin SATA data connector and a 15-pin SATA power connector.

According to the SATA standard, the eleventh pin port of a SATA power connector may be used for purposes of a Staggered Spin-Up (SSU). When several disk drives are connected to a single host device, the SSU function sequentially starts each disk drive upon power-on of the host device to transit the disk drive to a standby state. According to an embodiment of the inventive concept, the purpose of the eleventh pin port of the SATA power connector is changed to real-time monitoring of an external power connection state of the host device in the storage device. In other words, in an embodiment of the inventive concept, the eleventh pin port of the SATA power connector is used as a port for real-time monitoring of an external power connection state of the host device, rather than for the SSU purpose.

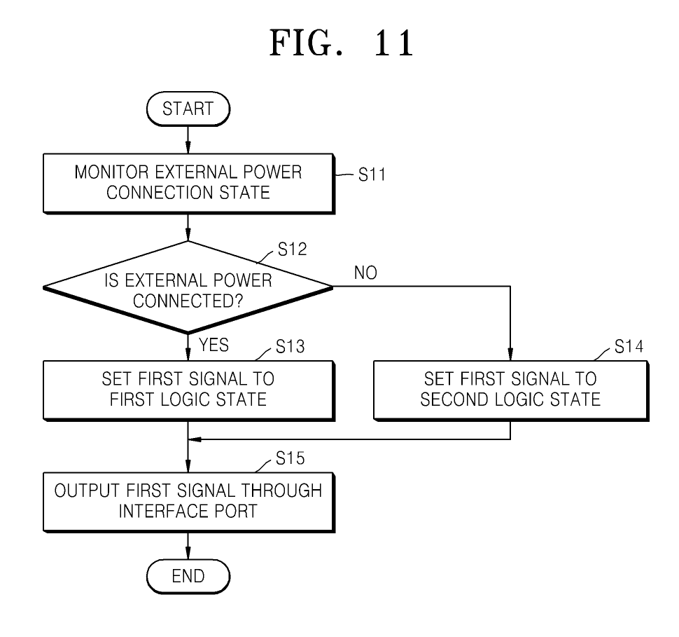

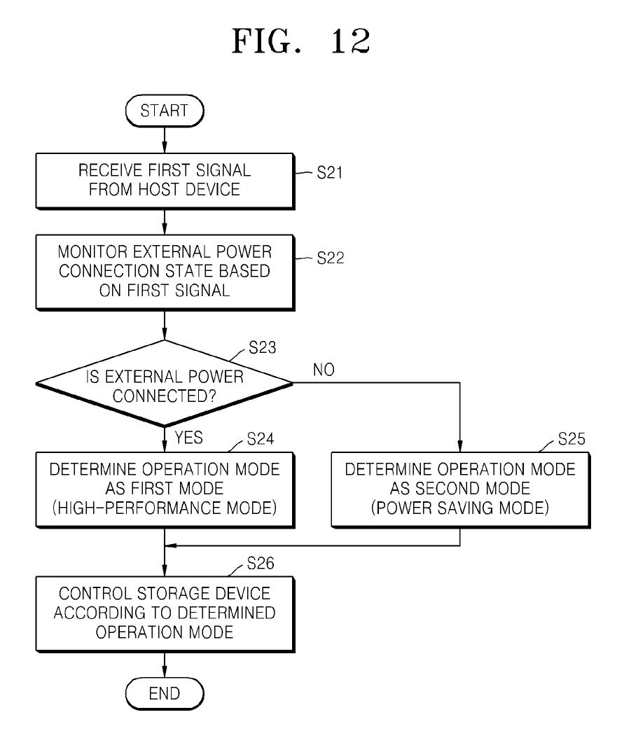

Referring to the storage device 1000, the processor 110 interprets commands and controls components of the storage device 1000 according to the interpretation results. The processor 110 may include a code object management unit, and may load a code object stored in the media 150 to the RAM 130 using the code object management unit. For example, the processor 110 loads code objects in RAM 130 for executing a method of controlling an operation mode of a storage device, as shown in the flowchart of FIG. 12. The processor 110 then executes a task for controlling an operation mode of a storage device, according to the flowchart shown in FIG. 12, using the code objects loaded in the RAM 130. The method of controlling an operation mode of a storage device executed by the processor 110 will be described in detail with reference to FIGS. 11 and 12.

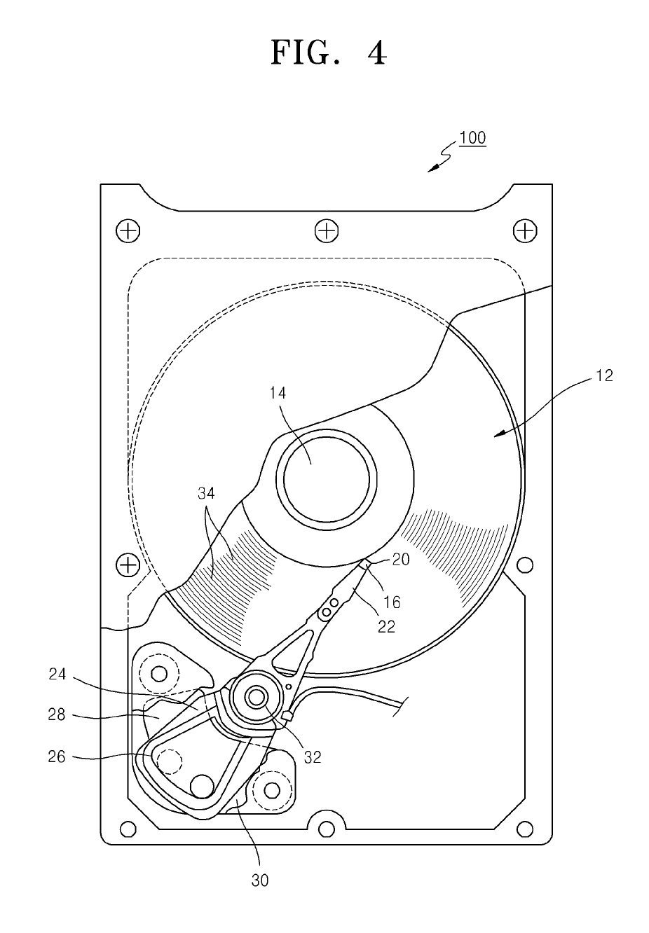

The ROM 120 of the storage device 100 stores program codes and data necessary for operating the storage device 1000. The program codes and data stored in the ROM 120 and/or the media 150 are loaded in the RAM 130 under control of the processor 110. The media 150 is a main storage medium of the storage device 1000, and may include a disk or a non-volatile semiconductor memory device, for example. The storage device 1000 may thus include a disk drive, for example, and a detailed structure of a head disk assembly 100, including a disk and a head in the disk drive, as shown in FIG. 4.

Referring to FIG. 4, the illustrative head disk assembly 100 includes at least one disk 12 rotated by a spindle motor 14. The disk drive may also include a head 16 positioned adjacent to a surface of the disk 12.

The head 16 senses and magnetizes a magnetic field of each disk 12, thereby reading information from or writing information to the rotating disk 12. Typically, the head 16 is associated with a surface of each disk 12. The head 16 includes a write head (not shown) for magnetizing the disk 12 and a separate read head (not shown) for sensing the magnetic field of the disk 12. The read head may include a Magneto-Resistive (MR) element. The head 16 may be referred to as a magnetic head or a transducer.

The head 16 may be incorporated into a slider 20. The slider 20 is configured to generate an air bearing between the head 16 and the surface of the disk 12. The slider 20 is coupled to a head gimbal assembly 22 that is attached to an actuator arm 24 having a voice coil 26. The voice coil 26 is positioned adjacent to a magnetic assembly 28 so as to define a Voice Coil Motor (VCM) 30. A current provided to the voice coil 26 generates a torque which rotates the actuator arm 24 with respect to a bearing assembly 32. The rotation of the actuator arm 24 moves the head 16 across the surface of the disk 12.

Information is usually stored in ring-shaped tracks 34 of the disk 12. Each track 34 generally includes multiple sectors. One track is composed of servo information fields in which servo information is written and data sectors in which data is stored. Multiple data sectors may be provided between servo information fields. Alternatively, the track may be designed to include a single data sector between servo information fields.

A logic block address is allocated to a writable region of the disk 12. In the disk drive, the logic block address is converted into cylinder/head/sector information to designate a writable region of the disk 12. The disk 12 may be divided into a maintenance cylinder region, which cannot be accessed by a user, and a user data region, which can be accessed by the user. The maintenance cylinder region may also be referred to as a system region. The maintenance cylinder region stores various information necessary for controlling the disk drive and also information necessary for controlling an operation mode of the storage device 1000.

The head 16 moves across the surface of the disk 12 to read information from or write information in another track. The disk 12 may store multiple code objects for implementing various functions with the disk drive. For example, a code object for performing an MP3 player function, a code object for performing a navigation function, and a code object for executing various video games may be stored in the disk 12.

Referring again to FIG. 1, the media I/F 140 enables the processor 110 to access the media 150, and to write or read information. In the storage device 1000 implemented with the disk drive, for example, the media I/F 140 includes a servo circuit for controlling the head disk assembly 100 and a read/write channel circuit for performing signal processing for data read/write operations.

The host I/F 160 performs data transmission/reception with the host device 2000, which may be a Personal Computer (PC), a mobile device, or the like, for example. The host I/F 160 may incorporate use of various standards, such as a Serial Advanced Technology Attachment (SATA) interface, a Parallel Advanced Technology Attachment (PATA) interface, and a Universal Serial Bus (USB) interface, for example. The bus 170 delivers information between components of the storage device 1000.

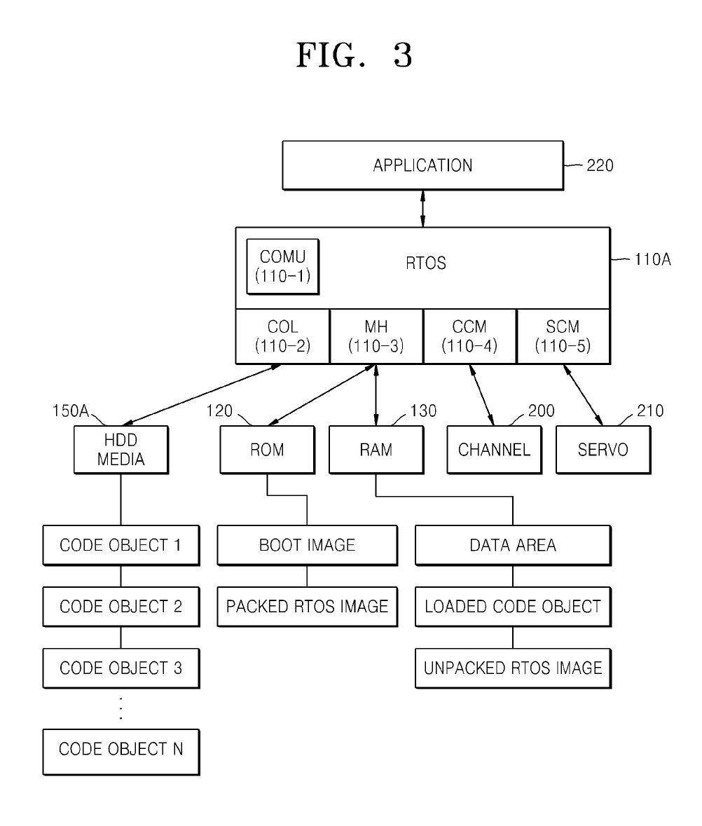

Next, a software operating system of a Hard Disk Drive (HDD) as an example of the storage device 1000 will be described with reference to FIG. 3.

As shown in FIG. 3, the media 150 of an HDD includes multiple code objects 1 through N. The ROM 120 stores a boot image and a packed Real Time Operating System (RTOS) image. The disk, indicated as HDD media 150A, stores the multiple code objects 1 through N. The code objects 1 through N stored in the disk may include not only code objects necessary for an operation of the disk drive, but also code objects related to various functions extensible to the disk drive. For example, the disk may also store code objects for executing the flowchart shown in FIG. 12, which illustrates a method of controlling an operation mode of the storage device 1000, according to an embodiment of the inventive concept. However, the code objects for executing the flowchart shown in FIG. 12 may also be stored in the ROM 120 instead of the disk, the HDD media 150A. Code objects for executing various functions, such as an MP3 player function, a navigation function, and a video game function, for example, may also be stored in the disk.

An unpacked RTOS image of the boot image is read from the ROM 120 to the RAM 130 during a booting process. Code objects necessary for host interfacing, which are stored in the HDD media 150A, are loaded to the RAM 130. A data region for storing data is also allocated to the RAM 130. Circuits necessary for performing signal processing for data read/write operations are embedded in a channel circuit 200, and circuits necessary for controlling the head disk assembly 100 for data read/write operations are embedded in a servo circuit 210.

An RTOS 110A is a real-time operating system program, and may be a multi-program operating system using a disk, for example. According a task, real-time multi-processing is performed in the foreground having a high priority and collective processing is performed in the background having a low priority. The RTOS 110A loads a code object from and unloads a code object to a disk.

The RTOS 110A manages a Code Object Management Unit (COMU) 110-1, a Code Object Loader (COL) 110-2, a Memory Handler (MH) 110-3, a Channel Control Module (CCM) 110-4, and a Servo Control Module (SCM) 110-5 to execute a task corresponding to a requested command. The RTOS 110A also manages application programs 220. For example, the RTOS 110A loads code objects necessary for controlling the disk drive to the RAM 130 during a process of booting the disk drive. Thus, after execution of the booting process, the disk drive may be driven using the code objects loaded to the RAM 130.

The COMU 110-1 stores information about an address at which the code objects are written, converts the virtual address into a real address, and mediates the bus 170. The COMU 110-1 also stores information about priorities of tasks being executed. The COMU 110-1 manages Task Control Block (TCB) information and stack information necessary for task execution regarding a code object.

The COL 110-2 loads code objects stored in the HDD media 150A to the RAM 130 by using the COMU 110-1, or unloads code objects stored in the RAM 130 to the HDD media 150A. Thus, the COL 110-2 may load code objects in the RAM 130 for executing the method of controlling an operation mode of a storage device, shown as the flowchart in FIG. 12. e RTOS 110A is able to execute the method of controlling an operation mode of a storage device shown in FIG. 12 using the code objects loaded to the RAM 130.

The MH 110-3 may write data to or read data from the ROM 120 and the RAM 130. The CCM 110-4 performs channel control necessary for performing signal processing for data read/write operations, and the SCM 110-5 performs servo control of a head disk assembly for data read/write operations.

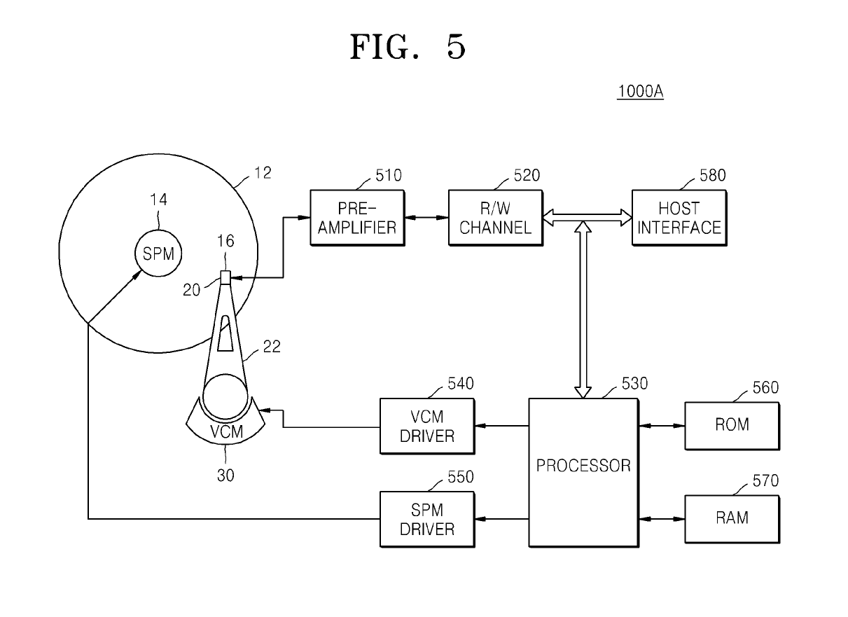

FIG. 5 shows an electrical structure of a disk drive as an example of the storage device 1000 shown in FIG. 1, according to an embodiment of the inventive concept.

As shown in FIG. 5, a disk drive 1000A, according to an embodiment of the inventive concept includes a pre-amplifier 510, a Read/Write (R/W) channel 520, a processor 530, a Voice Coil Motor (VCM) driver 540, a Spindle Motor (SPM) driver 550, an ROM 560, a RAM 570, and a host interface 580.

The processor 530 may be a Digital Signal Processor (DSP), a microprocessor, a microcontroller, or the like. The processor 530 controls the R/W channel 520 to read information from the disk 12 or write information to the disk 12 according to a command received from the host device 2000 through the host interface 580. The processor 530 is coupled to the VCM driver 540 which provides a driving current for driving the VCM 30. The processor 530 provides a control signal to the VCM driver 540 to control motion of the head 16.

The processor 530 is coupled to the SPM driver 550, which provides a driving current for driving an SPM 14. The processor 530, upon being supplied with power, provides a control signal to the SPM driver 550 to rotate the SPM 14 at a target speed.

The processor 530 is also coupled to the ROM 560 and the RAM 570. The ROM 560 stores firmware and control data for controlling the disk drive. The ROM 560 also stores program codes and information for executing the method of controlling an operation mode of a storage device, according to an embodiment of the inventive concept, as shown in FIG. 12. Alternatively, the program codes and information for executing the method of controlling an operation mode of a storage device according to an embodiment of the inventive concept as shown in FIG. 12 may be stored in the maintenance cylinder area of the disk 12, instead of the ROM 560.

The RAM 570 temporarily stores the program codes loaded from the ROM 560 or the disk 12 in an initialization mode, or data received through the host interface 580 or read from the disk 12 under the control of the processor 530. The RAM 570 may be implemented by a Dynamic Random Access Memory (DRAM) or a Synchronous Random Access Memory (SRAM). The RAM 570 may be designed to operate in a Single Data Rate (SDR) or Double Data Rate (DDR) scheme. The processor 530 may adaptively control an operation mode of a storage device according to the flowchart shown in FIG. 12 using program codes and information stored in the ROM 560 or the maintenance cylinder area of the disk 12.

A disk drive may perform data read operations and data write operations. In the data read operation, the disk drive amplifies an electrical signal sensed by the head 16 from the disk 12 through the pre-amplifier 510. Thereafter, in the R/W channel 520, a signal output from the pre-amplifier 510 is amplified by an automatic gain control circuit (not shown), which automatically varies a gain according to an amplitude of the signal. The amplified signal is converted into a digital signal, and then the digital signal is decoded, thereby detecting data. An error correction process is performed on the detected data by using a Reed Solomon (RS) code as an error correction code at the processor 530. Then error corrected data is converted into stream data for transmission to the host device 2000 through the host interface 580.

In the data write mode, the disk drive receives data from the host device 2000 through the host interface 580, and adds an error correction symbol based on the RS code to the data through the processor 530. The disk drive suitably performs coding for a writing channel through the R/W channel 520, and then writes the data in the disk 12 through the head 16 with a writing current amplified by the pre-amplifier 510.

An example of implementing the storage device 1000 of the computer system with the disk drive has been described above with reference to FIGS. 3 through 5. Of course, the storage device 1000 of the computer system may be implemented as a Solid State Drive (SSD) as well as a disk drive. The SSD may also be referred to as a solid state disk or a semiconductor disk device.

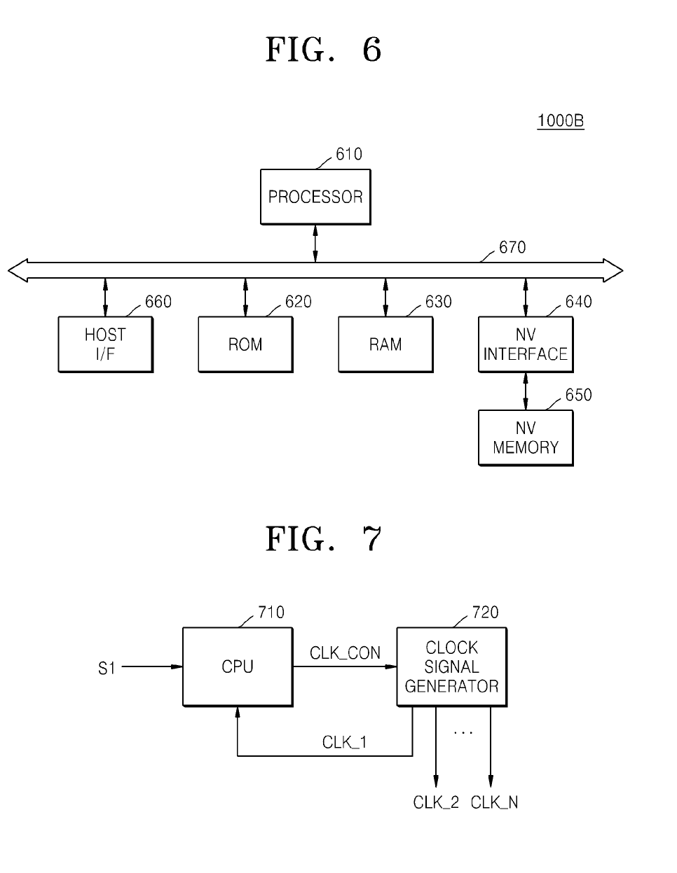

FIG. 6 shows an example of implementing the storage device 1000 of the computer system using SSD 1000B.

As shown in FIG. 6, the storage device 1000 of FIG. 1 is implemented by the SSD 1000B, which includes a processor 610, ROM 620, RAM 630, a Non-Volatile (NV) interface 640, an NV memory 650, a host interface 660, and a bus 670.

The ROM 620 stores program codes necessary for controlling the SSD 1000B. For example, the ROM 620 may store program codes for executing a Flash Translation Layer (FTL) function necessary for mapping of a flash memory embodied by the NV memory 650.

The NV memory 650 may be a flash memory device, a Phase change RAM (PRAM) device, a Ferroelectric RAM (FRAM) device, or a Magnetic RAM (MRAM) device, for example. For purposes of discussion, the NV memory 650 is assumed to be, but not limited to, a flash memory device. The NV memory 650 may be a single flash memory or multiple flash memories to expand memory capacity.

The flash memory device is a memory device on which an overwrite operation cannot be performed. Thus, to write data to the flash memory device again, an erase operation has to be performed first. The unit of writing data in the flash memory device is smaller than the unit of erasing data from the flash memory device. To omit the erase operation with respect to the flash memory device, the FTL function is used between a file system (not shown), which may be stored in the host device in the form of software, and the flash memory device. The FTL function maps a logic block address, generated by the file system in a data write operation with respect to the flash memory device, to a physical block address of the flash memory device at which the erase operation is performed. This function is called an address mapping function. Using the address mapping function of the FTL function, the host device 2000 is able to recognize the SSD 1000B implemented with the flash memory device as an HDD, thereby accessing the flash memory device in the same manner as with the HDD. The FTL function also executes bad block management and data integrity management in case of unexpected power interruption.

The processor 610 controls access to the RAM 630. The RAM 630 may be a DRAM or an SRAM, for example. The RAM 630 may also be designed to be driven in an SDR or DDR scheme. The RAM 630 temporarily stores data delivered between the NV memory 650 and the host device 2000. The processor 610 loads program codes necessary for executing the FTL function, which are stored in the ROM 620, to the RAM 630 during the booting process.

The NV interface 640 exchanges data with the NV memory 650. The NV interface 640 may perform data transmission between the NV memory 650 and the RAM 630 using, for example, an ultra DMA protocol.

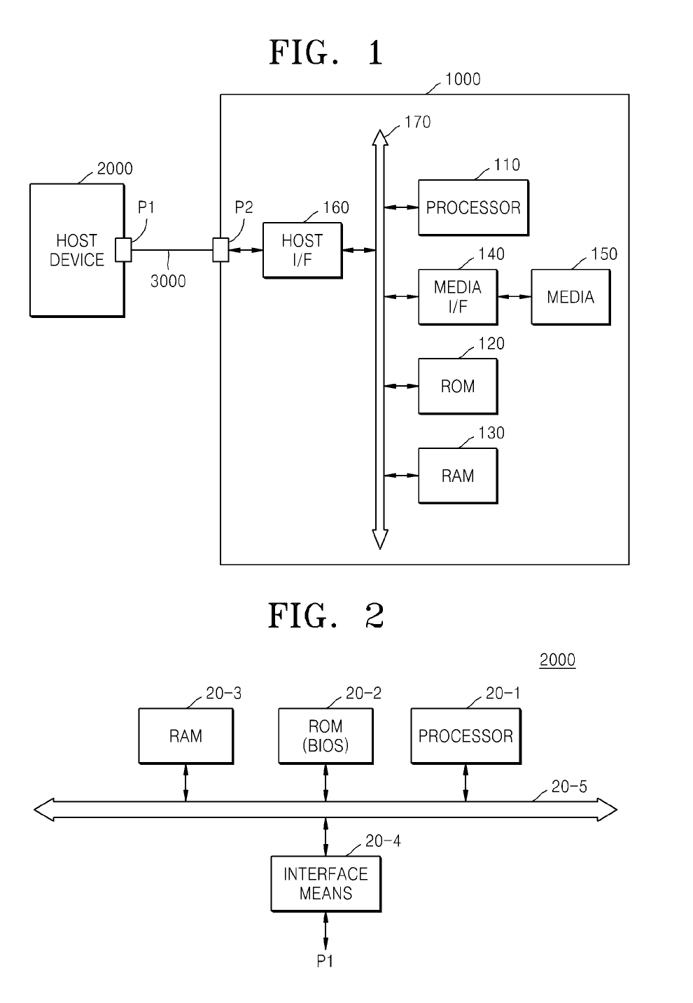

Operation of the host device 2000 of FIG. 1 will be described in more detail with reference to FIG. 2. As shown in FIG. 2, the host device 2000 includes a processor 20-1, ROM 20-2, RAM 20-3, interface means 20-4, and a bus 20-5.

The ROM 20-2 stores a Basic Input/Output System (BIOS) program. The BIOS program, which includes the most basic processing function of a computer, is an operating system program for controlling information transmission between the computer and peripheral devices. In particular, in an embodiment of the inventive concept, the BIOS program includes a program which determines a connection state between the host device 2000 and external power (or external power connection state of the host device 2000), and generates a signal corresponding to the determination result, according to the method depicted in the flowchart shown in FIG. 11. The external power may be battery power or Direct Current (DC) power provided by a power supply unit (not shown), for example.

The processor 20-1 controls components of the host device 2000 using the BIOS program stored in the ROM 20-2. For example, the processor 20-1 may control execution of the method shown in FIG. 11 using the BIOS program. Program codes stored in the ROM 20-2 or data received through the interface means 20-4 under the control of the processor 20-1 are loaded in the RAM 20-3.

The interface means 20-4 performs data transmission/reception processing with an external device through input/output terminals installed in the host device 2000. The interface means 20-4 may incorporate an interface in accordance with various standards, such as, an Accelerated Graphics port (AGP) interface, a Universal Serial Bus (USB) interface, an IEEE1394 interface, a Personal Computer Memory Card International Association (PCMCIA) interface, a Local Area Network (LAN) interface, a Bluetooth interface, a High Definition Multimedia Interface (HDMI), a Programmable Communication Interface (PCI), an Industry Standard Architecture (ISA) interface, a Peripheral Component Interconnect-Express (PCI-E) interface, an express card interface, an SATA interface, a PATA interface, or a serial interface, for example. The bus 20-5 delivers information between components of the host device 2000.

Referring to FIG. 11, the method of controlling an operation mode of a storage device is executed by the host device 2000 of the computer system, according to an embodiment of the inventive concept, under the control of the processor 20-1 of the host device 2000 shown in FIG. 2.

In operation S11, the processor 20-1 monitors the external power connection state of the host device 2000 using the BIOS program stored in the ROM 20-2. It is determined based on the monitoring result whether the external power is connected to the host device 2000 in operation S12. When the external power is connected to the host device 2000 (operation S12: Yes), a first signal is set to a first logic state in operation S13. Otherwise, when the external power is not connected to the host device 2000 (operation S12: No), the first signal is set to a second logic state in operation S14. For example, the first logic state may be a logic high state and the second logic state may be a logic low state.

The first signal is output through interface port P1 of FIG. 1 in operation S15. For example, when an SATA interface is used, the first signal may be output through the eleventh pin port of an SATA power connector. In this way, the eleventh pin of the SATA power connector is in the first logic state when the external power is connected to the host device 2000, and is in the second logic state when the external power is not connected to the host device 2000. Of course, in alternative configurations, various interfaces other than the SATA interface may be used, and a particular pin port of a connector used in the interface may be assigned as the pin port for transmitting the first signal. A new pin may be added to a connector used for the interface to transmit the first signal.

In the embodiment of the inventive concept according to the flowchart shown in FIG. 11, the external power connection state of the host device 2000 is monitored using the BIOS program, and the first signal corresponding to the monitoring result is output, e.g., to the eleventh pin port of the SATA power connector. In addition, the external power connection state may also be determined, as described below.

More particularly, the external power may be directly connected to a particular pin port of the connector 3000. For example, when an SATA interface is used as the host interface, the external power is directly connected to the eleventh port of the SATA power connector. Then, the first signal indicating the external power connection state, which is provided to the eleventh pin port of the SATA power connector, becomes an external power signal. In this case, the eleventh pin port of the SATA power connector is in the logic high state when the external power is connected to the host device 2000, otherwise, the eleventh pin port is in the logic low state.

An operation mode of the storage device 1000 of the computer system may be controlled as follows. The processor 110 of the storage device 1000 shown in FIG. 1 is structured as shown in FIG. 7, according to an embodiment of the inventive concept. For example, when the storage device 1000 is implemented by the disk drive, the processor 530 of the disk drive shown in FIG. 5 is structured as shown in FIG. 7. Likewise, when the storage device 1000 is implemented by an SSD, the processor 610 of the SSD shown in FIG. 6 is structured as shown in FIG. 7.

Referring to FIG. 7, the processor 110 includes a Central Processing Unit (CPU) 710 and a clock signal generator 720. The CPU 710 determines an operation mode of the storage device 1000 based on a logic state of a first signal 51 input through connector 3000 connected with the host device 2000. The CPU 710 controls the storage device 1000 according to the determined operation mode and generates a clock control signal CLK_CON corresponding to the determined operation mode.

For example, when the eleventh pin port of the SATA power connector is assigned as a pin port of the connector 3000 for transmitting the first signal 51 indicating the external power connection state of the host device 2000, the CPU 710 determines that the external power is connected to the host device 2000 when the logic state of the eleventh pin port is in the first logic state (e.g., high state), and thus determines the operation mode of the storage device 1000 as a first mode. When the logic state is in the second logic state (e.g., low state), the CPU 710 determines that the external power is not connected to the host device 2000 and thus determines the operation mode of the storage device 1000 as a second mode. The second mode has lower power consumption of the storage device 1000 than the first mode. For example, the first mode may be a high performance mode in which the performance of the storage device 1000 is set to the maximum, and the second mode may be a power saving mode in which power consumption is reduced by lowering the performance of the storage device 1000.

The CPU 710 blocks transition of the storage device 1000 to an idle state in the first mode and permits transition of the storage device 1000 to the idle state in the second mode. That is, the CPU 710 controls the storage device 1000 not to transit to the idle state even when a command is not received from the host device 2000 for a predetermined time in a standby state in the first mode. However, the CPU 710 controls the storage device 1000 to transit to the idle state when a command is not received from the host device 2000 for a predetermined time in a standby state in the second mode. For example, when the storage device 1000 is a disk drive and transits to the idle state in the second mode, the CPU 710 unloads the head 16 and cuts off power supplied to the VCM 30, the pre-amplifier 510, and the read/write channel circuit 520 to minimize power consumption of the disk drive. When the storage device 1000 is an SSD and transits to an idle state in the second mode, the CPU 710 cuts off power supplied to the NV interface 640 and the NV memory 650, thereby minimizing power consumption of the SSD.

The clock signal generator 720 generates one or more clock signals CLK_1 through CLK_N, which are frequency-variable according to a clock control signal CLK_CON. Clock signals generated by the clock signal generator 720 include a clock signal used by at least the CPU 710 and a clock signal used in a memory device included in the storage device 1000. When the storage device 1000 is a disk drive, the memory device may include the RAM 570 and the ROM 560. When the storage device 1000 is an SSD, the memory device may include the RAM 630, the ROM 620, and the NV memory 650.

For example, in the disk drive, the clock signal CLK_1 generated by the clock signal generator 720 may be provided as a clock signal for the CPU 710 of the processor 530. A clock signal CLK_2 generated by the clock signal generator 720 may be provided as a clock signal for the RAM 570. A clock signal CLK_N generated by the clock signal generator 720 may be provided as a clock signal for the ROM 560.

As another example, in the SSD, the clock signal CLK_1 generated by the clock signal generator 720 may be provided as a clock signal for the CPU 710 of the processor 610. The clock signal CLK_2 generated by the clock signal generator 720 may be provided as a clock signal for the RAM 630. A clock signal CLK_3 (not shown) generated by the clock signal generator 720 may be provided as a clock signal for the ROM 620. The clock signal CLK_N generated by the clock signal generator 720 may be provided as a clock signal for the NV memory 650.

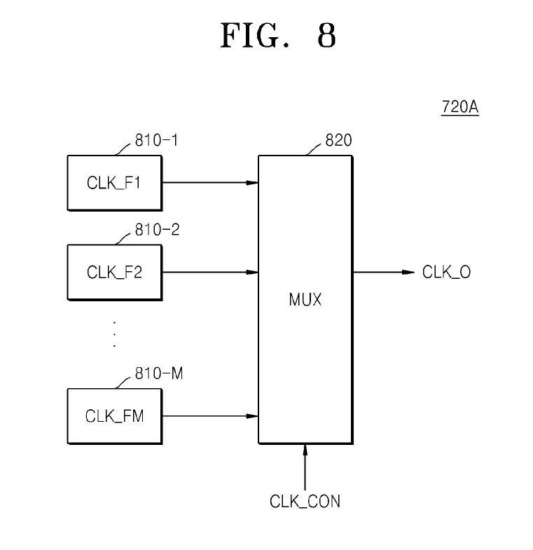

FIG. 8 shows a detailed structure of a clock signal generator 720A, according to an embodiment of the inventive concept.

As shown in FIG. 8, the clock signal generator 720A according to an embodiment of the inventive concept includes multiple clock generators 810-1 through 810-M and a multiplexer 820. The clock generators 810-1 through 810-M are means for generating clock signals having different frequencies, and may be implemented by oscillating circuits. For example, a frequency of a clock signal generated by the clock generator 810-1 (CLK_F1) may be the lowest frequency and a frequency of a clock signal generated by the clock generator 810-M (CLK_FM) may be the highest frequency.

The multiplexer 820 receives the clock signals having different frequencies generated by the clock generators 810-1 through 810-M, and selects and outputs one of the received clock signals according to a clock control signal CLK_CON. The multiplexer 820 may be designed such that a frequency of a clock signal selected in the first mode is higher than a frequency of a clock signal selected in the second mode according to the clock control signal CLK_CON.

For example, when the operation mode is determined to be the first mode, the clock control signal CLK_CON controls the multiplexer 820 to select the clock signal having the highest frequency generated by the clock generator 810-M (CLK_FM) among the clock signals generated by the clock generators 810-1 through 810-M. When the operation mode is determined to be the second mode, the clock control signal CLK_CON controls the multiplexer 820 to select a clock signal having a frequency set by default, generated by the clock generator 810-M, from among the clock signals generated by the clock generators 810-1 through 810-M. Herein, the frequency set by default may be the lowest frequency or an intermediate frequency among the frequencies of the clock signals generated by the clock generators 810-1 through 810-M.

An output clock signal CLK_O selected by the multiplexer 820 is provided to the CPU 710 or a memory device included in the storage device 1000. Thus, the output clock signal CLK_O output from the multiplexer 820 is used as a clock signal for the CPU 710 or the memory device included in the storage device 1000.

Although a single clock signal generator 720A for generating a clock signal used in the CPU 710 or the memory device included in the storage device 1000 is shown in FIG. 8, it is understood that the clock signal generator circuit may be implemented by multiple clock signal generators, i.e., as many as the number of clock signals to be used for the storage device 1000, in order to vary a frequency of a clock signal for each operation mode.

For example, when the storage device 1000 is implemented with the disk drive, a clock signal having a frequency that varies according to an operation mode is set to a clock signal to be used in each of the CPU 710 of the processor 530, the RAM 570, and the ROM 560. Thus, clock signals having three different frequencies are generated using three clock signal generator circuits, such as the clock signal generator 720A shown in FIG. 8. To change the frequencies of clock signals for the CPU 710 of the processor 530 and the RAM 570, clock signals having two different frequencies may be generated by using two clock signal generator circuits, such as the clock signal generator 720A shown in FIG. 8.

When the storage device 1000 is implemented with an SSD, a clock signal having a frequency that varies according to an operation mode is set to a clock signal to be used in each of the CPU 710 of the processor 610, the RAM 630, the ROM 620, and the NV memory 650. Thus, clocks having four different frequencies are generated using four clock signal generator circuits, such as the clock signal generator 720A shown in FIG. 8.

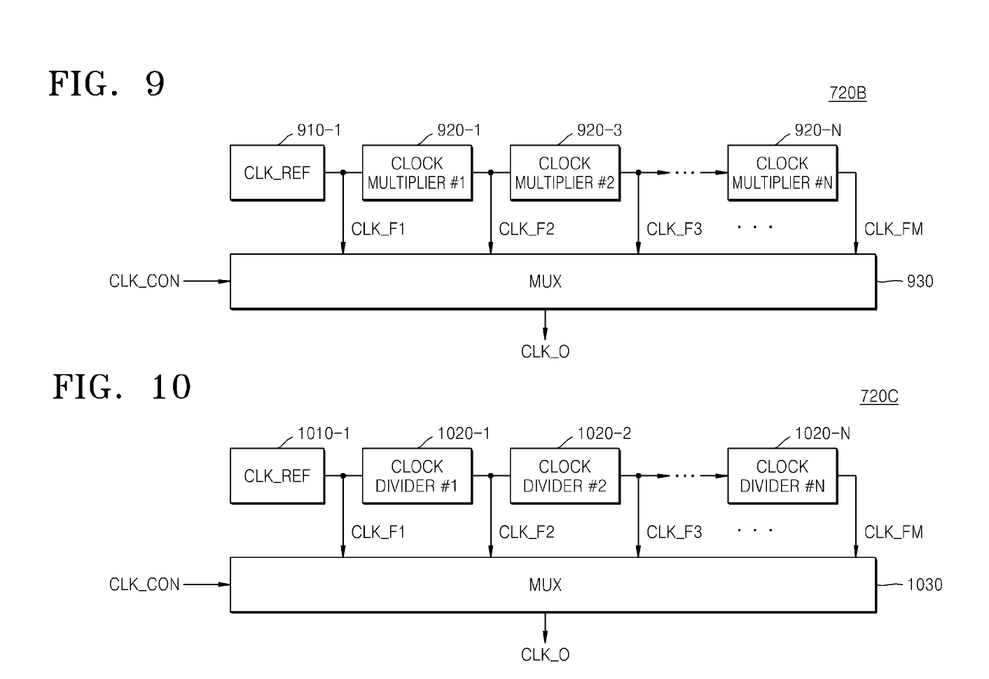

FIG. 9 shows a detailed structure of a clock signal generator 720B, according to another embodiment of the inventive concept.

As shown in FIG. 9, the clock signal generator 720B, according to another embodiment of the inventive concept, includes a reference clock generator 910-1, multiple clock multipliers 920-1 through 920-n, and a multiplexer 930. The reference clock generator 910-1 (CLK_REF) is an oscillating circuit, for example, that generates a reference clock signal CLK_F1. The reference clock generator 910-1 (CLK_REF) may determine a clock signal having the lowest frequency permitted by the CPU 710 or the memory device included in the storage device 1000, which uses the reference clock signal CLK_F1 as the reference clock signal CLK_F1.

Each of the clock multipliers 920-1 through 920-N is a well known circuit for increasing a frequency of an input clock signal by two times. Thus, a frequency of a clock signal CLK_F2 output from a clock multiplier #1 920-1 is two times the frequency of the reference clock signal CLK_F1. In this way, the frequency of a clock signal CLK_FM output from a clock multiplier #N 920-N is 2^{N} times the frequency of the reference clock signal CLK_F1.

The multiplexer 930 receives clock signals output from the reference clock generator 910-1 and the clock multipliers 920-1 through 920-N, and selects and outputs one of the received clock signals according to the clock control signal CLK_CON. The multiplexer 930 is designed such that a frequency of a clock signal selected in the first mode is higher than a frequency of a clock signal selected in the second mode, according to the clock control signal CLK_CON.

For example, when the operation mode is determined to be the first mode, the clock control signal CLK_CON controls the multiplexer 930 to select the clock signal CLK_FM having the highest frequency from among the clock signals input to the multiplexer 930. When the operation mode is determined to be the second mode, the clock control signal CLK_CON controls the multiplexer 930 to select a clock signal having a frequency set by default. Herein, the frequency set by default may be the lowest frequency or an intermediate frequency among the frequencies of the clock signals input to the multiplexer 930.

The output clock signal CLK_O selected in the multiplexer 930 is provided to the CPU 710 or the memory device included in the storage device 1000. Thus, the output clock signal CLK_O output from the multiplexer 930 is used as a clock signal for the CPU 710 or the memory device included in the storage device 1000.

Although a single clock signal generator 720B for generating a clock signal used in the CPU 710 or the memory device included in the storage device 1000 is shown in FIG. 9, it is understood that the clock signal generator circuit may be implemented by multiple clock signal generators, i.e., as many as the number of clock signals to be used for the storage device 1000, in order to vary a frequency of a clock signal for each operation mode.

For example, when the storage device 1000 is implemented with the disk drive, a clock signal having a frequency that varies according to an operation mode is set to a clock signal to be used in each of the CPU 710 of the processor 530, the RAM 570, and the ROM 560. Thus, clock signals having three different frequencies are generated using three clock signal generator circuits, such as the clock signal generator 720B shown in FIG. 9. To change frequencies of clock signals for the CPU 710 of the processor 530 and the RAM 570, clock signals having two different frequencies may be generated using two clock signal generator circuits, such as the clock signal generator 720B shown in FIG. 9.

When the storage device 1000 is an SSD, a clock signal having a frequency that varies according to an operation mode is set to a clock signal to be used in each of the CPU 710 of the processor 610, the RAM 630, the ROM 620, and the NV memory 650. Thus, clock signals having four different frequencies may be generated using four clock signal generator circuits, such as the clock signal generator 720B shown in FIG. 9.

FIG. 10 shows a detailed structure of a clock signal generator 720C, according to still another embodiment of the inventive concept.

As shown in FIG. 10, the clock signal generator 720C according to another embodiment of the inventive concept includes a reference clock generator 1010-1, multiple clock dividers 1020-1 through 1020-N, and a multiplexer 1030. The reference clock generator 1010-1 (CLK_REF) is an oscillating circuit, for example, that generates a reference clock signal CLK_F1. The reference clock generator 1010-1 (CLK_REF) may determine a clock signal having the highest frequency permitted by the CPU 710 or the memory device included in the storage device 1000, which uses the reference clock signal CLK_F1 as the reference clock signal CLK_F1.

Each of the clock dividers 1020-1 through 1020-N may be a well known circuit for reducing a frequency of an input clock signal by two times. Thus, a frequency of a clock signal CLK_F2 output from a clock divider #1 1020-1 is ½ times a frequency of the reference clock signal CLK_F1. In this way, a frequency of a clock signal CLK_FM output from a clock divider #N 1020-N is ½^{M} times the frequency of the reference clock signal CLK_F1.

The multiplexer 1030 receives the clock signals output from the reference clock generator 910-1 and the clock dividers 1020-1 through 1020-N, and selects and outputs one of the received clock signals according to the clock control signal CLK_CON. The multiplexer 1030 is designed such that a frequency of a clock signal selected in the first mode is higher than a frequency of a clock signal selected in the second mode, according to the clock control signal CLK_CON.

For example, when the operation mode is determined to be the first mode, the clock control signal CLK_CON controls the multiplexer 1030 to select the clock signal CLK_F1 having the highest frequency from among the clock signals input to the multiplexer 1030. When the operation mode is determined to be the second mode, the clock control signal CLK_CON controls the multiplexer 1030 to select a clock signal having a frequency set by default. Herein, the frequency set by default may be the lowest frequency or an intermediate frequency among the frequencies of the clock signals input to the multiplexer 1030.

The output clock signal CLK_O selected in the multiplexer 1030 is provided to the CPU 710 or the memory device included in the storage device 1000. Thus, the output clock signal CLK_O output from the multiplexer 1030 is used as a clock signal for the CPU 710 or the memory device included in the storage device 1000.

Although a single clock signal generator 720C for generating a clock signal used in the CPU 710 or the memory device included in the storage device 1000 is shown in FIG. 10, it is understood that the clock signal generator circuit may be implemented by multiple clock signal generators, i.e., as many as the number of clock signals to be used for the storage device 1000 in order to vary a frequency of a clock signal for each operation mode.

For example, when the storage device 1000 is a disk drive, a clock signal having a frequency that varies according to an operation mode is set to a clock signal to be used in each of the CPU 710 of the processor 530, the RAM 570, and the ROM 560. Thus, clock signals having three different frequencies are generated using three clock signal generator circuits, such as the clock signal generator 720C shown in FIG. 10. To change frequencies of clock signals for the CPU 710 of the processor 530 and the RAM 570, clock signals having two different frequencies may be generated using two clock signal generator circuits, such as the clock signal generator 720C shown in FIG. 10.

When the storage device 1000 is an SSD, a clock signal having a frequency that varies according to an operation mode is set to a clock signal to be used in each of the CPU 710 of the processor 610, the RAM 630, the ROM 620, and the NV memory 650. Thus, clock signals having four different frequencies are generated using four clock signal generator circuits, such as the clock signal generator 720C shown in FIG. 10.

In the foregoing operations, the operation mode of the storage device 1000 is determined based on the external power connection state of the host device 2000 and the storage device 1000 is controlled according to the determination result. For example, according to the external power connection state, frequencies of clock signals for the CPU of the processor and the memory device of the storage device 1000 can be adaptively varied.

A method of controlling an operation mode of the storage device 1000, executed by the storage device 1000 of the computer system, under the control of the processor 110 of the storage device 1000, is described with reference to FIG. 12. For reference, the processor 110 of the storage device 1000 of the computer system shown in FIG. 1 corresponds to the processor 530 shown in FIG. 5 when the storage device 1000 is a disk drive and corresponds to the processor 610 shown in FIG. 6 when the storage device 1000 is an SSD.

The processor 110 of the storage device 1000 receives a first signal from the host device 2000 indicating a connection state of the host device 2000 with external power (or external power connection state of the host device 2000) in operation S21. As described above with reference to FIG. 2, the host device 2000 may generate the first signal indicating the external power connection state using the BIOS program. The storage device 1000 may receive the first signal through the connector 3000 connected with the host device 2000. That is, the connector 3000 may include a power connector. For example, the connector 3000 may include an SATA interface power connector and the first signal may be transmitted to the storage device 1000 through the eleventh pin port of the SATA power connector. Thus, in an embodiment of the inventive concept, the eleventh pin port of the SATA power connector is used by the storage device 1000 to monitor in real time the external power connection state of the host device 2000. In other words, the eleventh pin port of the SATA power connector is specified and used for real-time monitoring of the external power connection state of the host device 2000, instead of being used for the SSU purpose.

The first signal may also be generated by connecting the external power supplied to the host device 2000 directly to a particular pin port of the connector 3000. For example, when the SATA interface scheme is used as the host interface scheme, the external power is connected directly to the eleventh pin port of the SATA power connector. Then, the first signal indicating the external power connection state, applied to the eleventh pin port of the SATA power connector, serves as an external power signal.

Next, the processor 110 of the storage device 1000 monitors the external power connection state of the host device 2000 based on the received first signal in operation S22. That is, the processor 110 monitors in real time the logic state of the eleventh pin port of the SATA interface power connector connected to the interface port P2, through which the first signal is received.

The processor 110 of the storage device 1000 determines the external power connection state of the host device 2000 based on the logic state of the eleventh pin port of the SATA interface power connector in operation S23. That is, the processor 110 of the storage device 1000 determines that the external power is connected to the host device 2000 when the logic state of the eleventh pin port is in the first logic state (high state). When the logic state is in the second logic state (low state), the CPU 710 determines that the external power is not connected to the host device 2000.

When the processor 110 of the storage device 1000 determines that the external power is connected to the host device 2000 (operation S23: Yes), it determines the operation mode of the storage device 1000 to be a first mode, which is a high-performance mode, in operation S24. For example, the first mode may be an operation mode in which the maximum performance of the storage device 1000 is exhibited.

When the processor 110 of the storage device 1000 determines that the external power is not connected to the host device 2000 (operation S23: No), it determines the operation mode of the storage device 1000 to be a second mode, which is a power saving mode, in operation S25. The second mode is an operation mode where power consumption of the storage device 1000 is lowered when compared to in the first mode.

Next, the processor 110 of the storage device 1000 controls the storage device 1000 according to the determined operation mode in operation S26. That is, the processor 110 blocks transition of the storage device 1000 to an idle state in the first mode and permits transition of the storage device 1000 to the idle state in the second mode. In other words, the processor 110 controls the storage device 1000 not to transit to the idle state in the first mode even when a command is not received from the host device 2000 for a predetermined time or more in the standby state. On the other hand, the processor 110 controls the storage device 1000 to transit to the idle state in the second mode when a command is not received from the host device 2000 for the predetermined time or more in the standby state.

For example, when the storage device 1000 is a disk drive, when the storage device 1000 transits to the idle state in the second mode, the processor 530 unloads the head 16 and cuts off power supplied to the VCM 30, the pre-amplifier 510, and the R/W channel circuit 520, thereby minimizing power consumption of the disk drive. When the storage device 1000 is an SSD, when the storage device 1000 transits to the idle state in the second mode, the processor 610 cuts off power supplied to the NV interface 640 and the NV memory 650 to minimize power consumption of the SSD.

The processor 110 of the storage device 1000 controls a frequency of a clock signal used in the storage device 1000 to be varied according to the determined operation mode. The processor 110 sets a frequency of a clock signal (clock frequency) for the CPU or the memory device included in the storage device 1000 in the first mode to be higher than that in the second mode. By increasing the clock frequency for the CPU or the memory device included in the storage device 1000, data processing speed is increased, but power consumption also increases. On the other hand, by lowering the clock frequency, the data processing speed is lowered, but power consumption is reduced, and thus, energy efficiency is improved.

For example, in the first mode, the clock frequency for the CPU or the memory device included in the storage device 1000 is set higher in the first mode. In the second mode, the clock frequency may be set to a default frequency. Herein, the frequency set by default may an intermediate frequency among clock frequencies operable in the CPU or the memory device included in the storage device 1000.

Therefore, the storage device 1000 operates in the first mode to have the best performance by giving priority to performance over energy efficiency, and operates in the second mode to save power by giving priority to energy efficiency over performance.

The inventive concept may be implemented as a method, an apparatus, and a system. When implemented as software, components of the inventive concept are code segments for executing the various tasks or operations. Programs or code segments may be stored in a processor-readable medium. Examples of the processor-readable medium include an electronic circuit, a semiconductor memory device, a ROM, a flash memory, an Erasable ROM (EROM), a floppy disk, an optical disk, a hard disk, and so forth.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of controlling an operation mode of a storage device, the method comprising:
determining, by the storage device, an external power connection state of a host device connected to the storage device; and
determining the operation mode of the storage device according to the determined external power connection state, wherein the operation mode is determined to be a first mode when external power is connected to the host device and the operation mode is determined to be a second mode when the external power is not connected to the host device, power consumption in the second mode being smaller than power consumption in the first mode.

2. The method of claim 1, further comprising:
monitoring, by the host device, the external power connection state of the host device;
generating a first signal indicating the external power connection state of the host device based on the monitoring; and
transmitting the first signal to the storage device, wherein the external power connection state of the host device is determined by the storage device based on the first signal.

3. The method of claim 2, wherein the external power connection state of the host device is monitored using a Basic Input/Output System (BIOS) program stored in the host device.

4. The method of claim 2, wherein the first signal is transmitted to the storage device through a connector which connects the host device with the storage device.

5. The method of claim 4, wherein the connector comprises a power connector.

6. The method of claim 4, wherein the connector comprises a Serial Advanced Technology Attachment (SATA) interface power connector, and the first signal is transmitted to the storage device through an eleventh pin port of the SATA interface power connector.

7. The method of claim 1, wherein determining the external power connection state of the host device comprises receiving a signal having a logic state of a particular pin port of a connector, which connects the host device with the storage device, and determining the external power connection state based on the logic state.

8. The method of claim 1, wherein a clock frequency of a Central Processing Unit (CPU) included in the storage device or a clock frequency of a memory device is set to be higher in the first mode than in the second mode.

9. The method of claim 1, wherein transition of the storage device to an idle state is blocked in the first mode, and the transition of the storage device to the idle state is permitted in the second mode.

10. A storage device comprising:
a connector electrically connecting a host device with the storage device and configured to transmit a first signal indicating an external power connection state of the host device to the storage device; and
a processor configured to determine an operation mode of the storage device based on the first signal received through the connector and to control the storage device according to the determined operation mode,
wherein the processor determines the operation mode of the storage device to be a first mode when the external power connection state indicates that external power is connected to the host device and determines the operation mode of the storage device to be a second mode, in which power consumption is smaller than in the first mode, when the external power is not connected to the host device.

11. The storage device of claim 10, wherein the connector comprises a Serial Advanced Technology Attachment (SATA) interface power connector, in which an eleventh pin port thereof is assigned as a pin port for transmitting the first signal.

12. The storage device of claim 10, wherein the processor determines the external power connection state of the host device by using a Basic Input/Output System (BIOS) program stored in the host device to generate the first signal.

13. The storage device of claim 10, wherein the first signal comprises an external power signal of the host device.

14. The storage device of claim 10, wherein the processor comprises:
a Central Processing Unit (CPU) configured to determine the operation mode of the storage device based on a logic state of the first signal and to generate a clock control signal corresponding to the determined operation mode; and
a clock signal generator configured to generate one or more clock signals having frequencies that vary according to the clock control signal,
wherein the clock signals generated by the clock signal generator comprise a clock signal used in the CPU or a memory device, and a frequency of a clock signal generated in the first mode is set to be higher than a frequency of a clock signal generated in the second mode.

15. The storage device of claim 14, wherein the clock signal generator comprises:
a clock source generator configured to generate a plurality of clock signals having different frequencies; and
a multiplexer configured to select and output one of the plurality of clock signals according to the clock control signal,
wherein the multiplexer sets a frequency of a clock signal selected and output in the first mode to be higher than a frequency of a clock signal selected and output in the second mode.

16. A method of controlling an operation mode of a storage device, the method comprising:
monitoring, by a host device connected to the storage device, a connection state of external power of the host device;
determining whether the external power is connected to the host device based on the monitoring of the external power connection state;
setting a first signal to a first logic state when the external power is determined to be connected to the host device, and setting the first signal to a second logic state when the external power is determined to be not connected to the host device; and
transmitting the first signal to the storage device, wherein the operation mode of the storage device is determined based on the first signal.

17. The method of claim 16, wherein the external power connection state of the host device is monitored using a BIOS program.

18. The method of claim 16, wherein the first logic state comprises a logic high state and the second logic state comprises a logic low state.

19. The method of claim 16, wherein the operation mode is determined to be a first mode when the first signal is set to the first logic state and is determined to be a second mode when the first signal is set to the second logic state, power consumption in the second mode being smaller than power consumption in the first mode.

20. The method of claim 16, wherein the operation mode is determined to be a first mode when the first signal is set to the first logic state and is determined to be a second mode when the first signal is set to the second logic state, performance of the storage device in the first mode being higher than performance of the storage device in the second mode.
